(19) United States
(12) Patent Application Publication
(10) Pub. No.: US 2026/0154599 A1
(43) Pub. Date: Jun. 4, 2026

(54) QUANTUM ENHANCED VULNERABILITY MANAGEMENT

(71) Applicant: American Express Travel Related Services Company, Inc., New York, NY (US)

(72) Inventor: Hiranmayi Palanki, Tallahassee, FL (US)

(21) Appl. No.: 18/965,234

(22) Filed: Dec. 2, 2024

(51) Int. Cl. G06N 10/70; G06F 21/57

(52) U.S. Cl. CPC G06N 10/70; G06F 21/577

(57) ABSTRACT

Disclosed are various embodiments for optimizing the prioritization of vulnerability risk remediation. In various examples, vulnerability scans can be performed to identify one or more vulnerabilities in a computing infrastructure. A vulnerability graph can be generated to represent the individual and aggregate risks of vulnerabilities based at least in part on the scanning data and dependency data. In various examples, the vulnerability graph can be defined as a maximum cut problem and the quantum approximate optimization algorithm (QAOA) can be used to solve the maximum cut problem and optimize the prioritization of vulnerability risk remediation.

### BACKGROUND

A vulnerability can correspond to a weakness within a computing system (e.g., software, hardware, firmware, etc.) that can weaken the security of the overall infrastructure of the computing system. Vulnerability management includes scanning the system to identify vulnerabilities within the computing infrastructure for remediation and/or mitigation. In some systems, the complexity of application architecture and the use of open-source software packages can significantly increase the number of vulnerabilities that a system may have at a given time. The prioritization of vulnerability remediation at scale is increasingly difficult due to the large number of vulnerabilities and the traditional techniques of relying primarily on the individual risks of each vulnerability.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIGS. 2A and 2B are drawings depicting an example vulnerability graph according to various embodiments of the present disclosure.

FIG. 3 is a flowchart illustrating one example of functionality implemented as portions of an application executed in a computing environment in the network environment of FIG. 1 according to various embodiments of the present disclosure.

FIG. 4 is a flowchart illustrating one example of functionality implemented as portions of an application executed in a computing environment in the network environment of FIG. 1 according to various embodiments of the present disclosure.

### DETAILED DESCRIPTION

Disclosed are various approaches for optimizing the prioritization of vulnerability risk remediation. In particular, the present disclosure relates to vulnerability risk remediation accounting for individual vulnerability risks along with interlinkages between vulnerabilities to enable an improvement in computation in aggregate vulnerability risks. In various examples, vulnerabilities scans can be used to identify vulnerabilities within a computing infrastructure. The individual risks and the aggregate risks can be analyzed to determine a priority for vulnerability remediation.

In various examples, the present disclosure leverages quantum approximate optimization algorithm (QAOA) to optimize the prioritization of vulnerability risk remediation. QAOA is specifically useful for handling combinatorial optimization problems that are difficult for classical algorithms to solve. In the case of the present disclosure, the optimization is focused on selecting the most critical vulnerabilities to remediate first, based on their individual and aggregate risks. In various examples, vulnerabilities are identified from vulnerability scanning of the computing infrastructure of the system being evaluated. The vulnerability scanning can include one or more scanning methods such as, for example, Static Application Security Testing (SAST), Dynamic Application Security Testing (DAST), Software Composition Analysis (SCA), API scanning, and/or other vulnerability scanning techniques (e.g., container scans, host scans, secrets scans). In various examples, the vulnerability scanning can be initiated randomly, by user instruction, and/or according to a schedule. The outcome of the vulnerabilities scans can include scanning data that includes a common vulnerability scoring system (CVSS) score, an exploitability index score, and/or other type of score.

In various examples, the outcomes of the vulnerability scans are collected and categorized according to scanning data (e.g., CVSS scores, exploitability index) and the dependencies between the identified vulnerabilities. The categorized vulnerability data can be organized and represented as a graph structure (e.g., vulnerability graph). In the graph representation, the vulnerabilities are represented as nodes on the graph, and the interlinkages or dependencies between the vulnerabilities are shown as edges. The edges can be weighted based at least in part on factors that can include, for example, severity ratings (e.g., CVVS scores, exploitability index), asset risk, architectural risk, dependencies, etc.

In various examples, the graph can be used to define a maximum cut problem. A maximum cut splits the vulnerability graph into two disjoint sets such that the sum of the weights of the edges between the two sets is maximized. The solution of the maximum cut problem corresponds to a partition where the most critical relationships (vulnerabilities that strongly affect each other) are placed on opposite sides of the cut. In particular, a goal of the maximum cut problem is to partition the nodes of the graph into two sets of nodes to maximize the total weight of the cut edges. In this example, maximum cut problem is solved when the vulnerability graph is partitioned into two disjoint sets of nodes such that the total weight of the edges between the two sets of nodes is maximized. This represents the objective function for the maximum cut problem, where maximizing the sum of weights across the graph partition helps identify vulnerabilities that should be prioritized for remediation based at least in part on their interlinkages (e.g., dependencies) and overall impact on risk.

In vulnerability prioritization, maximizing the weight of the cut means that vulnerabilities with stronger interconnections (and hence higher risk when left unpatched together) are separated. This helps identify which set of vulnerabilities should be prioritized for immediate remediation based at least in part on the strength of the relationships between them. Vulnerabilities that are more connected to each other would be remediated in such a way that the riskiest vulnerabilities are dealt with first to reduce the overall risk.

In various examples, the partition of the maximum cut function can be defined such that Set 1 includes vulnerabilities that are to be remediated immediately. Set 2 of the graph could contain vulnerabilities that have lower priority for immediate remediation or that might be fixed later in the process. The separation is driven by the goal of maximizing the critical edges between the sets, representing that vulnerabilities with greater mutual impact should be dealt with in different remediation cycles.

In various examples, once the maximum cut problem is defined, the maximum cut problem can be encoded into a QAOA cost function, which iteratively explores potential solutions. In various examples, the QAOA optimization process for solving the maximum cut problem involves initialization of the quantum circuit, QAOA interactions, quantum state measurement and enhanced vulnerability prioritization. The quantum circuit can be initialized to represent a superposition of all vulnerability states of the vulnerabilities represented in the vulnerability graph, with Hadamard gates applied to each qubit. Phase and mixing operations (implemented as rotations around the Z and X axes of the qubits) are applied iteratively to explore the solution space and evolve towards lower cost solutions. After several iterations, the quantum state is measured, collapsing it into classical states that represent the most optimal vulnerability remediation strategies. The final quantum state is analyzed to determine the most optimal set of vulnerabilities to remediate first.

In various examples, the solution of the present disclosure accounts for both individual vulnerability risks (as represented by CVSS scores) and aggregated risks, which emerge from the dependencies and interlinkages between vulnerabilities. By leveraging QAOA, the present disclosure explores the combinatorial complexity of vulnerability prioritization more efficiently than classical methods, aiming to provide a more optimal remediation order based on interconnected risks. The cost function in QAOA ensures that vulnerabilities with higher interdependencies and risk profiles are remediated first, leading to a more efficient risk mitigation process overall.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

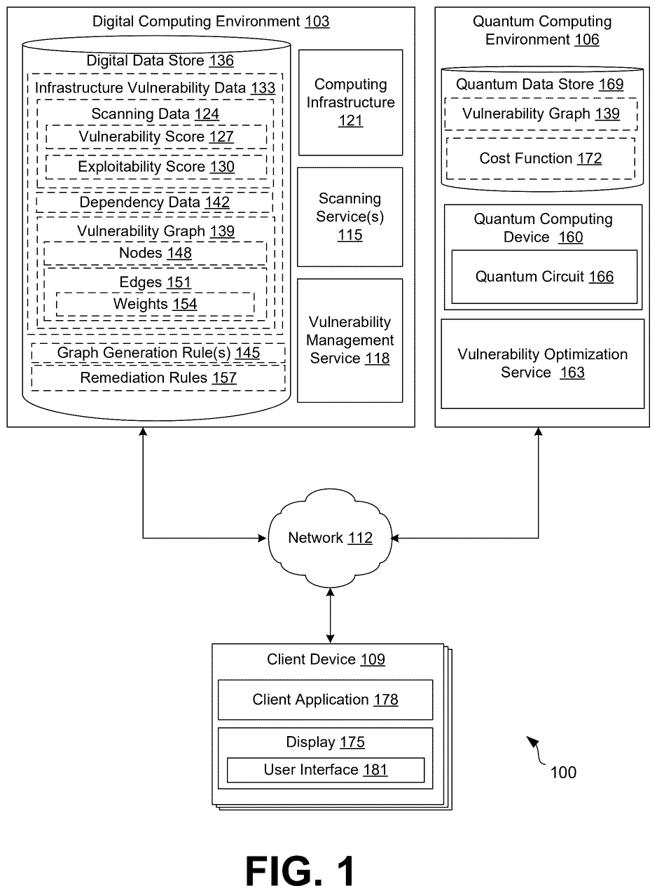

With reference to FIG. 1, shown is a network environment 100 according to various embodiments. The network environment 100 can include a digital computing environment 103, a quantum computing environment 106, and a client device 109, which can be in data communication with each other via a network 112. It should be noted that although the digital computing environment 103 and the quantum computing environment 106 are illustrated as being separate computing environments, in some examples, at least some of functionality of the digital computing environment 103 can be included in the quantum computing environment 106. In other examples, at least some of the functionality of the quantum computing environment 106 can be included in the digital computing environment 103.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The digital computing environment 103 can include one or more digital computing devices (e.g., devices configured to process traditional binary and/or bitwise data and process) that include a digital processor, a digital memory, and/or a network interface. For example, the digital computing devices can be configured to perform non-quantum computations on behalf of other digital computing devices or applications. As another example, such digital computing devices can host and/or provide content to other computing devices (e.g., digital computing devices or quantum computing devices) in response to requests for content. As another example, such digital computing devices can request that other computing devices (e.g., digital computing devices or quantum computing devices) provide content in response to a request by the digital computing device. In such an example, the digital computing device can receive the content from the other computing devices (e.g., digital computing devices or quantum computing devices) or from some other source.

Moreover, the digital computing environment 103 can employ a plurality of digital computing devices that can be arranged in one or more server banks or computer banks or other arrangements. Such computing devices can be located in a single installation or can be distributed among many different geographical locations. For example, the digital computing environment 103 can include a plurality of computing devices that together can include a hosted computing resource, a grid computing resource or any other distributed computing arrangement. In some cases, the digital computing environment 103 can correspond to an elastic computing resource where the allotted capacity of processing, network, storage, or other computing-related resources can vary over time.

Various applications or other functionality can be executed in digital computing environment 103. The components executed on the digital computing environment 103 include one or more scanning service(s) 115, a vulnerability management service 118, and other applications, services, processes, systems, engines, or functionality not discussed in detail herein.

The scanning service(s) 115 can be executed to evaluate a computing infrastructure 121 of one or more computing systems within the digital computing environment 103 and/or outside of the digital computing environment 103 in order to identify and/or report on vulnerabilities in networks, hardware, software, and/or other components of a given computing system. The computing infrastructure 121 can include a collection of hardware, software, firmware, and networks that support the operation, management, and security of one or more computing systems. In various examples, a vulnerability can correspond to a weakness within a computing system that can create a potential security compromise that can weaken the security of the overall infrastructure of the computing system. For example, a vulnerability can correspond to a privilege escalation, remote code execution, parameter tampering, account takeover, sensitive information disclosure, missing authorization, misconfigurations, insider threats, unpatched software, network vulnerabilities and/or other types of system vulnerabilities that can be detected by a scanning service 115 evaluating a computing infrastructure 121.

In various example, a scanning service 115 can be executed to perform one or more scanning methods such as, for example, Static Application Security Testing (SAST), Dynamic Application Security Testing (DAST), Software Composition Analysis (SCA), application programming interface (API) scanning, container scanning, host scanning, database scanning, network vulnerability scanning, and/or other type of vulnerability scanning. In various examples, the scanning service 115 can be executed randomly, by user instruction, and/or according to a schedule. The output of the vulnerability scans performed by the scanning service 115 can identify one or more vulnerabilities with corresponding scanning data 124. The scanning data 124 can include a vulnerability score 127 (e.g., a common vulnerability scoring system (CVSS) score), an exploitability score 130, and/or other type of score that can be used to evaluate the given vulnerability. The vulnerability score 127 can represent the rate of severity and risk of the given vulnerability. The exploitability score 130 can represent a likelihood that an attacker can attack the given vulnerability.

The vulnerability management service 118 can be executed to identify vulnerabilities within the computer infrastructure 121 and manage the remediation and/or mitigation of the identified vulnerabilities. In some examples, the vulnerability management service 118 can initiate the execution of the scanning service 115 to perform scans of one or more systems within the computing infrastructure 121 to identify vulnerabilities within the computing infrastructure 121. In other examples, the vulnerability management service 118 can obtain the scanning data 124 included in the infrastructure vulnerability data 133 stored in the digital data store 136 to identify vulnerabilities within the computing infrastructure 121. Upon identifying the vulnerabilities, the vulnerability management service 118 can manage the vulnerabilities by determining remediation and/or mitigation prioritization of the identified vulnerabilities.

In various examples, the vulnerability management service 118 can generate a vulnerability graph 139 that represents the identified vulnerabilities and interdependencies among vulnerabilities. The vulnerability graph 139 can be generated based at least in part on the scanning data 124, dependency data 142, the graph generation rules 145, and/or other data that can be used to represent the individual and aggregate vulnerabilities of the computing infrastructure 121. The vulnerability graph 139 can be generated such that the vulnerabilities are represented as nodes 148 on the graph 139, and the interlinkages or dependencies between the vulnerabilities are shown as edges 151. The edges 151 can include weights 154 that are based at least in part on factors that can include, for example, severity ratings (e.g., CVVS scores, exploitability index), asset risk, architectural risk, dependencies, etc. In various examples, the higher the weight 154, the more critical the interdependence between the vulnerabilities is considered.

In various examples, the vulnerability management service 118 can identify a remediation prioritization in which to remedy the vulnerabilities based at least in part on the individual and aggregate risks of the vulnerabilities. In various examples, the vulnerability management service 118 can interact with the quantum computing environment 106 and provide the vulnerability graph 139 to the quantum computing environment 106. According to various embodiments, the quantum computing environment 106 can define a maximum cut problem associated with the vulnerability graph 139 and solve the maximum cut problem using QAOA which optimizes the prioritization of vulnerabilities by using the maximum cut problem as a cost function. The output of the QAOA provides a priorities list of vulnerabilities to remediate first, which minimizes the overall risk in the computing infrastructure 121. The prioritized list of vulnerabilities can be returned to the vulnerability management service 118. Upon receiving the prioritized list of vulnerabilities, the vulnerability management service 118 can initiate the remediation of the vulnerabilities according to the prioritized list of vulnerabilities, the remediation rules 157 and/or other factors.

Also, various data is stored in a digital data store 136 that is accessible to the digital computing environment 103. The digital data store 136 can be representative of a plurality of digital data store 136, which can include relational databases or non-relational databases such as object-oriented databases, hierarchical databases, hash tables or similar key-value data stores, as well as other data storage applications or data structures. Moreover, combinations of these databases, data storage applications, and/or data structures can be used together to provide a single, logical, data store. The data stored in the digital data store 136 is associated with the operation of the various applications or functional entities described below. This data can include infrastructure vulnerability data 133, graph generation rules 145, remediation rules 157, and potentially other data.

The infrastructure vulnerability data 133 can include vulnerability data associated with the computing infrastructure 121 and can represent the risks and severity of one or more vulnerabilities detected in the computing infrastructure 121. The infrastructure vulnerability data 133 can include scanning data 124, dependency data 142, a vulnerability graph 139, and/or other data. The scanning data 124 can include the output of one or more scans performed by the scanning service(s) 115. The scanning data 124 can include a vulnerability score 127, exploitability score 130, and/or other data. The vulnerability score 127 can represent the rate of severity and risk of the given vulnerability. For example, the vulnerability score 127 can include a common vulnerability scoring system (CVSS) score. The exploitability score 130 (e.g., exploitability index) can represent a likelihood that an attacker can attack the given vulnerability.

The dependency data 142 can represent data defining dependencies between one or more vulnerability types. In various examples, the dependency data 142 for a given vulnerability can include a list of one or more other vulnerabilities that are interconnected with the given vulnerability. In various examples, the dependency data 142 can indicate a level of dependency on the one or more vulnerabilities. For example, a given vulnerability can be interconnected with a first vulnerability and a second vulnerability, but the first vulnerability is considered to be a greater critical dependency than the second vulnerability. The level of dependency between the different vulnerabilities can be defined in the dependency data 142.

The vulnerability graph 139 can represent the individual and aggregate vulnerabilities of the computing infrastructure 121. The vulnerability graph 139 can be generated based at least in part on the scanning data 124, dependency data 142, the graph generation rules 145, and/or other data that can be used to represent the individual and aggregate vulnerabilities of the computing infrastructure 121. The vulnerability graph 139 can be generated such that the identified vulnerabilities are represented as nodes 148 on the graph 139, and the interlinkages or dependencies between the vulnerabilities are shown as edges 151. The edges 151 can include weights 154 that are based at least in part on factors that can include, for example, severity ratings (e.g., CVVS scores, exploitability index), asset risk, architectural risk, dependencies, etc. In various examples, the higher the weight 154, the more critical the interdependence between the vulnerabilities is considered.

The graph generation rules 145 include rules, models, and/or configuration data for the various algorithms or approaches employed by the vulnerability management service 118 for generating the vulnerability graph 139. For example, the graph generation rules 145 can define approaches for calculating the weights 154 of each of the edges 151 of the vulnerability graph 139 based at least in part on the dependency data 142, the scanning data 124, and other data. In addition, the graph generation rules 145 can include rules, models, and/or configuration data that define how the vulnerabilities are to be connected to one another. In some examples, the graph generation rules 145 include rules, models, and/or configuration data that define how the vulnerability graph 139 is to be generated to be compatible with transformation to the maximum cut problem that is used to optimize the remediation priority for the identified vulnerabilities.

The remediation rules 157 include rules, models, and/or configuration data for the various algorithms or approaches employed by the vulnerability management service 118 for remediation of the identified vulnerabilities. In various examples, the remediation rules 157 can define approaches for how to remediate a given vulnerabilities, contact information for one or more individuals that are to be notified of the given vulnerabilities, and/or other information.

The quantum computing environment 106 can include one or more quantum computing devices 160 (e.g., devices configured to process quantum data formatted as “quantum bits” also called “qubits”) that include a quantum processor, a quantum memory, and/or a network interface. The quantum computing devices 160 can be referred to as a “quantum-based” or “qubit-based” computing architecture that performs operations using quantum bits or qubits that can represent multiple states at a given time for information storage and manipulation. The software executed using quantum computing devices 160 can also be referred to as “quantum-based,” or “qubit-based,” and can use qubit-based operations. The qubit can be considered a basic unit of information in quantum computing and quantum communications. The qubit can be maintained based at least in part on the spin of electron or polarization of a photon. The quantum computing devices 160 can be configured to perform quantum computations on behalf of other computing devices (e.g., digital computing devices) or applications (e.g., vulnerability optimization service 163, etc.). In some embodiments, quantum computing devices 160 can host and/or provide content to other computing devices (e.g., digital computing devices or quantum computing devices) in response to requests for content.

In various examples, a quantum computing device 160 can include a quantum circuit 166 which corresponds to a model for quantum computation that can be performed by the quantum computing device 160 to carry out the computation of the qubits. The quantum circuit 166 of the present disclosure can be designed to optimize the prioritization of vulnerabilities in a network of interconnected vulnerabilities, each with varying severity, dependencies, and risks. In various examples, the quantum circuit 166 includes a collection of interconnected quantum gates which are used in the transformations on the qubits. In various examples, the quantum circuit 166 can comprise Hadamard gates, phase separate gates, mixing gates, and/or other types of quantum gates. The Hadamard gate comprises a quantum logic gate that is used for the initialization of the quantum circuit 166 to create a superposition of all possible states (e.g., vulnerability configurations). A phase separator gate is a quantum logic gate that can be used to apply phase shifts passed on the maximum cut problem's cost function, effectively “penalizing” undesirable configurations. A mixing gate is a quantum logic gate that can be used to explore different configurations by rotating qubits around specific axes (e.g., Z and X rotations) during each iteration.

The quantum computing environment 106 can also include one or more digital computing devices (e.g., devices configured to process traditional binary and/or bitwise data and process) that include a digital processor, a digital memory, and/or a network interface. For example, the digital computing devices can be configured to perform non-quantum computations on behalf of other digital computing devices or applications. As another example, such digital computing devices can host and/or provide content to other computing devices (e.g., digital computing devices or quantum computing devices) in response to requests for content. As another example, such digital computing devices can request that other computing devices (e.g., digital computing devices or quantum computing devices) provide content in response to a request by the digital computing device. In such an example, the digital computing device can receive the content from the other computing devices (e.g., digital computing devices or quantum computing devices) or from some other source. By having both digital computing devices and quantum computing devices 160 on the quantum computing environment 106, the digital computing devices can act as an intermediary between other computing devices and the quantum computing devices 160, facilitating the execution of the necessary quantum processing with the quantum computing devices 160.

Moreover, the quantum computing environment 106 can employ a plurality of digital computing devices and/or quantum computing devices 160 that can be arranged in one or more server banks or computer banks or other arrangements. Such digital computing devices or quantum computing devices 160 can be located in a single installation or can be distributed among many different geographical locations. For example, the quantum computing environment 106 can include a plurality of digital computing devices and/or quantum computing devices 160 that together can include a hosted computing resource, a grid computing resource, or any other distributed computing arrangement. In some cases, the quantum computing environment 106 can correspond to an elastic computing resource, where the allotted capacity of processing, network, storage, or other computing-related resources can vary over time.

Various data can be stored in a quantum data store 169 that is accessible to the quantum computing environment 106. The quantum data store 169 can be representative of a plurality of quantum data stores 169, which can include relational databases or non-relational databases, such as object-oriented databases, hierarchical databases, hash tables, or similar key-value data stores, as well as other data storage applications, or data structures. Moreover, combinations of these databases, data storage applications, and/or data structures can be used together to provide a single, logical, data store. In various embodiments, the data stored in the quantum data store 169 can be structured as digital bits, representing how a qubit can be configured to represent the data. In other various embodiments, the data stored in the quantum data store 169 can store the data as a quantum state for easy retrieval by the quantum computing device 160. By storing the data as a quantum state, portions of the data can be stored in a quantum superposition, representing one or more possible states of the data. The data stored in the quantum data store 169 is associated with the operation of the various applications or functional entities described below. This data can include a vulnerability graph 139, a cost function 172, and potentially other data.

The vulnerability graph 139 can represent the individual and aggregate vulnerabilities for a computing infrastructure 121. In various examples, the vulnerabilities are represented as nodes 148 on the graph 139, and the interlinkages or dependencies between the vulnerabilities are shown as edges 151. The edges 151 can include weights 154 that are based at least in part on factors that can include, for example, severity ratings (e.g., CVVS scores, exploitability index), asset risk, architectural risk, dependencies, etc. In various examples, the vulnerability graph 139 is received by the vulnerability optimization service 163 from the vulnerability management service 118 with respect to a request for vulnerability prioritization.

The cost function 172 can represent the maximum cut problem that is defined from the vulnerability graph 139 in a format that is compliant with QAOA optimization. The goal of the cost function 172 is to minimize the overall risk of the system by prioritizing the most critical vulnerabilities for remediation. The cost function 172 incorporates both the individual risks (e.g., scanning data) and the aggregated risks based on the interdependencies between vulnerabilities.

Various applications or other functionality can be executed in the quantum computing environment 106. The components executed on the quantum computing environment 106 can include a vulnerability optimization service 163, a quantum computing device 160 and other applications, services, processes, systems, engines, or functionality not discussed in detail herein.

The vulnerability optimization service 163 can be executed to determine a remediation prioritization for vulnerabilities included in a vulnerability graph 139. In various examples, the vulnerability optimization service 163 can receive a vulnerability graph 139 from the vulnerability management service 118 of the digital computing environment 103 and convert the vulnerability graph 139 into a cost function 172 for QAOA optimization. In various examples, vulnerability optimization service 163 can define a maximum cut problem based at least in part on the vulnerability graph 139. Maximum cut splits the vulnerability graph 139 into two disjoint sets such that the sum of the weights 154 of the edges 151 between the two sets is maximized. The solution of the maximum cut problem corresponds to a partition where the most critical relationships (vulnerabilities that strongly affect each other) are placed on opposite sides of the cut. In particular, a goal of the maximum cut problem is to partition the nodes 148 of the vulnerability graph 139 into two sets to maximize the total weight 154 of the cut edges 151. In this example, maximum cut problem is solved when the vulnerability graph 139 is partitioned into two disjoint sets such that the total weight 154 of the edges 151 between the two sets is maximized. This represents the objective function for the maximum cut problem, where maximizing the sum of weights across the graph partition helps identify vulnerabilities that should be prioritized for remediation based at least in part on their interlinkages (e.g., dependencies) and overall impact on risk.

In various examples, the maximum cut problem can be defined such that Set 1 includes vulnerabilities that are to be remediated immediately and Set 2 of the vulnerability graph 139 contains vulnerabilities that have lower priority for immediate remediation or that might be fixed later in the process. The separation is driven by the goal of maximizing the critical edges between the sets, representing that vulnerabilities with greater mutual impact should be delt with in different remediation cycles.

In various examples, once the maximum cut problem is defined, vulnerability optimization service 163 encodes or otherwise maps the maximum cut problem into a QAOA cost function 172, which iteratively explores potential solutions. In various examples, the vulnerability optimization service 163 can initialize the quantum circuit 166 based at least in part on the cost function 172 and initiate the execution of the quantum circuit 166 on the quantum computing device 160. The quantum circuit 166 is initialized to represent a superposition of all vulnerability states of the vulnerabilities represented in the vulnerability graph, with Hadamard gates applied to each qubit. The qubits of the quantum circuit 166 represent the states of the vulnerabilities (e.g., whether a vulnerabilities belongs in Set 1 or Set 2). Phase and mixing operations (implemented as rotations around the Z and X axes of the qubits) are applied iteratively to explore the solution space and evolve towards lower cost solutions. In particular, iterative quantum operations are applied to the qubits, evolving the quantum state towards the solution that maximized the cost function 172. After several iterations, the quantum state is measured, collapsing it into classical states that represent the most optimal vulnerability remediation strategies. The final quantum state is analyzed to determine the most optimal set of vulnerabilities to remediate first.

In various examples, the output of the quantum circuit 166 includes a list of prioritized vulnerabilities. In various examples, the list of prioritized vulnerabilities can include a subset of the vulnerabilities that are included in the set that is defined to include the vulnerabilities that are to be remediated first. In various examples, the vulnerability optimization service 163 can obtain the output of the quantum circuit 166 and transmit the output to the vulnerability management service 118.

The client device 109 is representative of a plurality of client devices that can be coupled to the network 112. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays 175, such as liquid crystal displays (LCDs), gas plasma-based flat panel displays, organic light emitting diode (OLED) displays, electrophoretic ink (“E-ink”) displays, projectors, or other types of display devices. In some instances, the display 175 can be a component of the client device 109 or can be connected to the client device 109 through a wired or wireless connection.

The client device 109 can be configured to execute various applications such as a client application 178 or other applications. The client application 178 can be executed in a client device 109 to access network content served up by the digital computing environment 103 or other servers, thereby rendering a user interface 181 on the display 175. To this end, the client application 178 can include a browser, a dedicated application, or other executable, and the user interface 181 can include a network page, an application screen, or other user mechanism for obtaining user input. The client device 109 can be configured to execute applications beyond the client application 178 such as email applications, social networking applications, word processors, spreadsheets, or other applications.

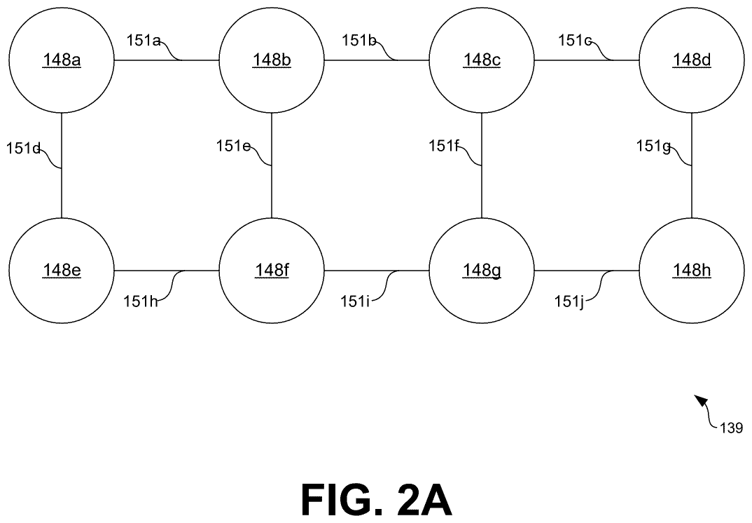

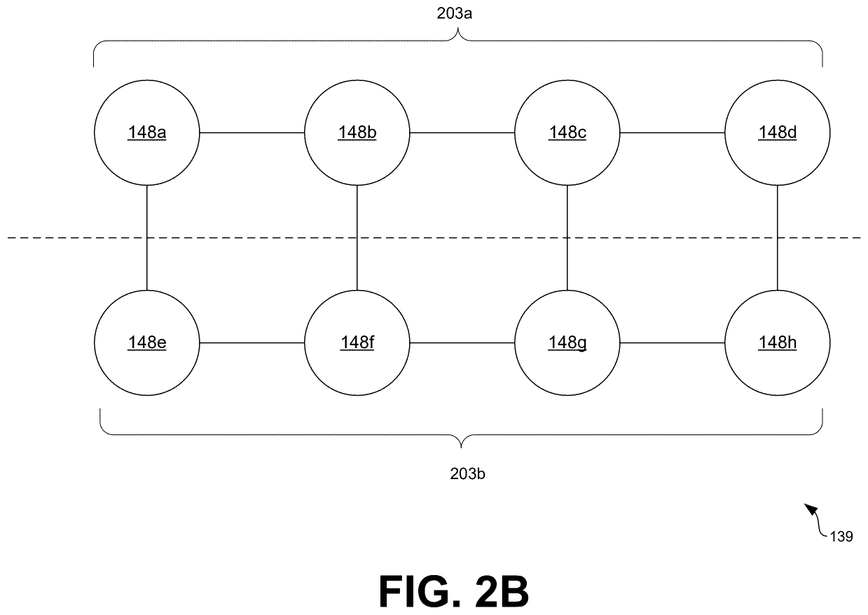

Next, a general description of the operation of the various components of the network environment 200 is provided with respect to FIGS. 2A-4. To begin, FIGS. 2A and 2B are drawings depicting an example vulnerability graph 139. FIG. 2A illustrates a visual representation of the vulnerability graph 139 as generated to the vulnerability management service 118 to represent the individual and aggregate vulnerabilities in a computing infrastructure. In the vulnerability graph 139, the vulnerabilities are represented as nodes 148 (e.g., 148a, 148b, 148c, 148d, 148e, 148f, 148g, 148h) and the interlinkages or dependencies between the vulnerabilities are shown as edges 151 (e.g., 151a, 151b, 151c, 151d, 151e, 151f, 151g, 151h, 151i, 151j). The edges 151 can include weights 154 (FIG. 1) that are based at least in part on factors that can include, for example, severity ratings (e.g., vulnerability scores 127, exploitability score 130), asset risk, architectural risk, dependencies, etc. In various examples, the higher the weight 154, the more critical the interdependence between the vulnerabilities is considered.

FIG. 2B illustrates a visual representation of the vulnerability graph 139 where the vulnerability graph is cut into two partitions 203 (e.g., 203a and 203b) as a result of the maximum cut problem being solved by QAOA. In various examples, the maximum cut problem can be defined such that Set 1 (e.g., partition 203a) includes vulnerabilities that are to be remediated immediately and Set 2 (e.g., partition 203b) of the vulnerability graph 139 contains vulnerabilities that have lower priority for immediate remediation or that might be fixed later in the process. The separation is driven by the goal of maximizing the critical edges 151 between the sets, representing that vulnerabilities with greater mutual impact should be delt with in different remediation cycles.

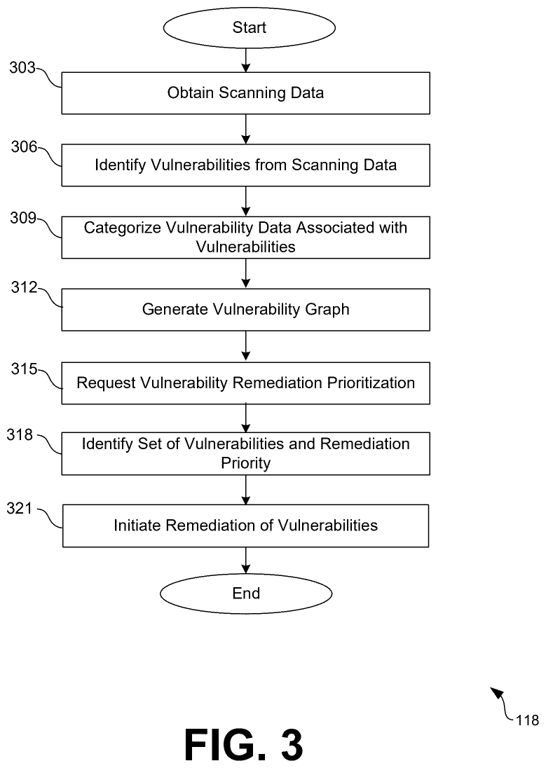

Referring next to FIG. 3, shown is a flowchart that provides one example of the operation of a portion of the vulnerability management service 118. The flowchart of FIG. 3 provides merely an example of the many different types of functional arrangements that can be employed to implement the operation of the depicted portion of the vulnerability management service 118 As an alternative, the flowchart of FIG. 3 can be viewed as depicting an example of elements of a method implemented within the network environment 100.

Beginning with block 303, the vulnerability management service 118 can obtain scanning data 124 associated with one or more scans of a computing infrastructure by one or more scanning services 115. In some examples, the scanning data 124 is obtained from the digital data store 138 as a result of scheduled scans. In other examples, the vulnerability management service 118 can initiate the scanning of the computing infrastructure 121 by requesting the scanning services 115 to perform the corresponding scans of the computing infrastructure 121.

The scanning data 124 can include outcome data from one or more scans including, for example, Static Application Security Testing (SAST), Dynamic Application Security Testing (DAST), Software Composition Analysis (SCA), application programming interface (API) scanning, container scanning, host scanning, database scanning, network vulnerability scanning, and/or other type of vulnerability scanning. The scanning data 124 can include a vulnerability score 127 (e.g., a common vulnerability scoring system (CVSS) score), an exploitability score 130, and/or other type of score that can be used to evaluate the given vulnerability. The vulnerability score 127 can represent the rate of severity and risk of the given vulnerability. The exploitability score 130 can represent a likelihood that an attacker can attack the given vulnerability.

At block 306, the vulnerability management service 118 can identify one or more types of vulnerabilities from the scanning data 124. In various examples, a vulnerability represented by the scanning data 124 can correspond to a weakness within a computing system that can create a potential security compromise that can weaken the security of the overall infrastructure of the computing system. For example, a vulnerability can correspond to a privilege escalation, remote code execution, parameter tampering, account takeover, sensitive information disclosure, missing authorization, misconfigurations, insider threats, unpatched software, network vulnerabilities and/or other types of system vulnerabilities that can be detected by a scanning service 115 evaluating a computing infrastructure 121. In various examples, the vulnerability management service 118 can identify the vulnerabilities from the results of the scans performed by the scanning services 115.

At block 309, the vulnerability management service 118 can categorize vulnerability data associated with the vulnerabilities. In various examples, a vulnerability can have individual risks denoted by the scanning data 124 and aggregate risks denoted by the dependency data. The vulnerability management service 118 can categorize the vulnerability associated with a given vulnerability according to the vulnerability score 127, exploitability score 130, dependency data 142, and/or other data. The categorized vulnerability data can be organized to be represented as a graph structure.

At block 312, the vulnerability management service 118 can generate the vulnerability graph 139 that represents the identified vulnerabilities and interdependencies among vulnerabilities. The vulnerability graph 139 can be generated based at least in part on the scanning data 124, dependency data 142, the graph generation rules 145, and/or other data that can be used to represent the individual and aggregate vulnerabilities of the computing infrastructure 121. The vulnerability graph 139 can be generated such that the vulnerabilities are represented as nodes 148 on the graph 139, and the interlinkages or dependencies between the vulnerabilities are shown as edges 151. The edges 151 can include weights 154 that are based at least in part on factors that can include, for example, severity ratings (e.g., CVVS scores, exploitability index), asset risk, architectural risk, dependencies, etc. In various examples, the higher the weight 154, the more critical the interdependence between the vulnerabilities is considered.

At block 315, the vulnerability management service 118 can request vulnerability remediation prioritization. In various examples, the vulnerability management service 118 can interact with the quantum computing environment 106 and provide the vulnerability graph 139 to the quantum computing environment 106 requesting a prioritized list of vulnerabilities for remediation based at least in part on the vulnerability graph 139.

At block 318, the vulnerability management service 118 can identify a set of vulnerabilities and corresponding remediation priority. In various examples, the vulnerability management service 118 can identify the set of vulnerabilities a corresponding remediation priority by obtaining a prioritized list of vulnerabilities from the quantum computing environment 106. According to various embodiments, the quantum computing environment 106 can define a maximum cut problem associated with the vulnerability graph 139 and solve the maximum cut problem using QAOA which optimizes the prioritization of vulnerabilities by using the maximum cut problem as a cost function 172. The output of the QAOA can provide a priorities list of vulnerabilities to remediate first, which minimizes the overall risk in the computing infrastructure 121. The prioritized list of vulnerabilities can be returned to the vulnerability management service 118.

At block 321, upon receiving the prioritized list of vulnerabilities, the vulnerability management service 118 can initiate the remediation of the vulnerabilities according to the prioritized list of vulnerabilities, the remediation rules 157 and/or other factors. In various examples, the remediation rules 157 can define approaches for how to remediate a given vulnerabilities, contact information for one or more individuals that are to be notified of the given vulnerabilities, and/or other information. Thereafter, this portion of the process proceeds to completion.

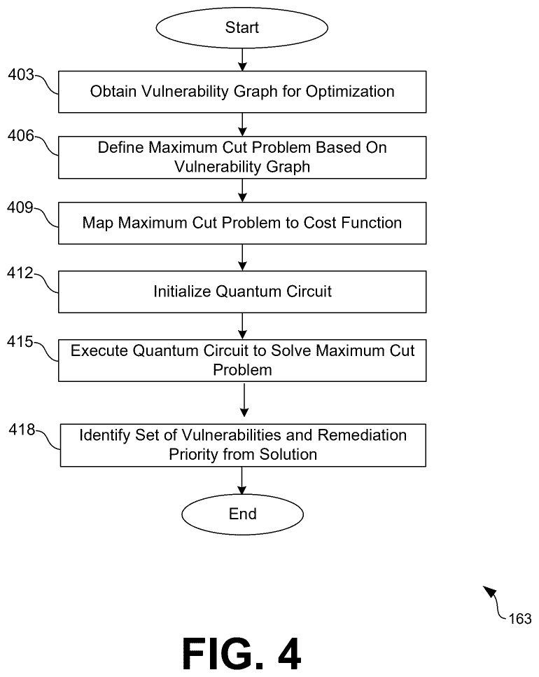

Turning now to FIG. 4, shown is a flowchart that provides one example of the operation of a portion of the vulnerability optimization service 163. The flowchart of FIG. 4 provides merely an example of the many different types of functional arrangements that can be employed to implement the operation of the depicted portion of the vulnerability optimization service 163. As an alternative, the flowchart of FIG. 4 can be viewed as depicting an example of elements of a method implemented within the network environment 100.

In various examples, FIG. 4 provides an example of the vulnerability optimization service 164 identifying a set of vulnerabilities and optimized prioritization of remediation according to the vulnerability graph 139. In particular, FIG. 4 discusses how a maximum cut problem is defined according to the vulnerability graph 139 and that the solution of the maximum cut problem includes a set of vulnerabilities and an optimized prioritization of remediation.

Beginning with block 403, the vulnerability optimization service 163 can obtain the vulnerability graph 139 for optimization. For example, the vulnerability optimization service 163 can receive a request for optimization from the vulnerability management service 118 and the request can include the vulnerability graph 139 to be analyzed.

At block 406, the vulnerability optimization service 163 can define the maximum cut problem based at least in part on the vulnerability graph 139. In various examples, vulnerability optimization service 163 can define a maximum cut problem based at least in part on the vulnerability graph 139. Maximum cut splits the vulnerability graph 139 into two disjoint sets such that the sum of the weights 154 of the edges 151 between the two sets is maximized. The solution of the maximum cut problem corresponds to a partition where the most critical relationships (vulnerabilities that strongly affect each other) are placed on opposite sides of the cut. In particular, a goal of the maximum cut problem is to partition the nodes 148 of the vulnerability graph 139 into two sets to maximize the total weight 154 of the cut edges 151. In this example, maximum cut problem is solved when the vulnerability graph 139 is partitioned into two disjoint sets such that the total weight 154 of the edges 151 between the two sets is maximized. This represents the objective function for the maximum cut problem, where maximizing the sum of weights across the graph partition helps identify vulnerabilities that should be prioritized for remediation based at least in part on their interlinkages (e.g., dependencies) and overall impact on risk.

In various examples, the maximum cut problem can be defined such that Set 1 includes vulnerabilities that are to be remediated immediately and Set 2 of the vulnerability graph 139 contains vulnerabilities that have lower priority for immediate remediation or that might be fixed later in the process. The separation is driven by the goal of maximizing the critical edges between the sets, representing that vulnerabilities with greater mutual impact should be delt with in different remediation cycles.

At block 409, the vulnerability optimization service 163 can map the maximum cut problem to a cost function 172. For example, the vulnerability optimization service 163 encodes or otherwise maps the maximum cut problem into a QAOA cost function that allows for quantum processing to iteratively explores potential solutions. The cost function 172 can represent the maximum cut problem that is defined from the vulnerability graph 139 in a format that is compliant with QAOA optimization. The goal of the cost function 172 is to minimize the overall risk of the system by prioritizing the most critical vulnerabilities for remediation. The cost function 172 incorporates both the individual risks (e.g., scanning data) and the aggregated risks based on the interdependencies between vulnerabilities.

At block 412, the vulnerability optimization service 163 can initialize the quantum circuit 166 based at least in part on the cost function 172. The quantum circuit 166 is initialized to represent a superposition of all vulnerability states of the vulnerabilities represented in the vulnerability graph, with Hadamard gates applied to each qubit. The qubits of the quantum circuit 166 represent the states of the vulnerabilities (e.g., whether a vulnerabilities belongs in Set 1 or Set 2).

At block 415, the vulnerability optimization service 163 can execute the quantum circuit 166 to solve the maximum cut problem. The solution of the maximum cut problem corresponds to a partition where the most critical relationships (vulnerabilities that strongly affect each other) are placed on opposite sides of the cut. In particular, a goal of the maximum cut problem is to partition the nodes 148 of the vulnerability graph 139 into two sets to maximize the total weight 154 of the cut edges 151. In this example, maximum cut problem is solved when the vulnerability graph 139 is partitioned into two disjoint sets such that the total weight 154 of the edges 151 between the two sets is maximized. This represents the objective function for the maximum cut problem, where maximizing the sum of weights across the graph partition helps identify vulnerabilities that should be prioritized for remediation based at least in part on their interlinkages (e.g., dependencies) and overall impact on risk. In various examples, phase and mixing operations (implemented as rotations around the Z and X axes of the qubits) are applied iteratively to explore the solution space and evolve towards lower cost solutions. In particular, using QAOA, iterative quantum operations are applied to the qubits, evolving the quantum state towards the solution that maximizes the cost function 172. After several iterations, the quantum state is measured, collapsing it into classical states that represent the most optimal vulnerability remediation strategies (e.g., partitions). The final quantum state is analyzed to determine the most optimal set of vulnerabilities to remediate first.

At block 418, the vulnerability optimization service 162 can identify a set of vulnerabilities and remediation priority from the solution of the maximum cut problem. In various examples, the output of the quantum circuit 166 includes a list of prioritized vulnerabilities. In various examples, the list of prioritized vulnerabilities can include a subset of the vulnerabilities that are included in the set that is defined to include the vulnerabilities that are to be remediated first. In various examples, the vulnerability optimization service 163 can obtain the output of the quantum circuit 166 and transmit the output to the vulnerability management service 118. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same digital computing environment 103 or quantum computing environment 106.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a digital computing device comprising a digital processor and a digital memory;
a quantum computing device in data communication with the digital computing device, the quantum computing device comprising a quantum processor and a quantum memory;
a first set of machine-readable instructions stored in the digital memory that, when executed by the digital processor, cause the digital computing device to at least:
initiate a scan of a computing infrastructure using one or more vulnerability scans to identify a plurality of vulnerabilities within the computing infrastructure; and
generate a vulnerability graph of the plurality of vulnerabilities, the graph being generated to include a plurality of nodes representing the plurality of vulnerabilities and a plurality of edges, individual edges of the plurality of edges representing a respective dependency between a respective two vulnerabilities of the plurality of vulnerabilities; and
a second set of machine-readable instructions stored in the quantum memory that, when executed by the quantum processor, cause the quantum computing device to at least:
identify a set of vulnerabilities from the plurality of vulnerabilities and an optimized prioritization of remediation for the set of vulnerabilities based at least in part on the vulnerability graph.

2. The system of claim 1, wherein when executed, the second set of machine-readable instructions cause the quantum computing device to at least partition the vulnerability graph into two disjointed sets such that a total weight of the plurality of edges between the two disjointed sets is maximized, the set of vulnerabilities corresponding to one disjointed set of the two disjointed sets.

3. The system of claim 2, wherein when executed, the second set of machine-readable instructions cause the quantum computing device to at least:
define a maximum cut problem based at least in part on the vulnerability graph and edge weights assigned to the plurality of edges of the vulnerability graph; and
convert the maximum cut problem into a cost function for quantum approximate optimization.

4. The system of claim 3, wherein the second set of machine-readable instructions cause the quantum computing device to at least initialize a quantum circuit with a superposition of every possible combination for partitioning the vulnerability graph into two possible sets of vulnerabilities.

5. The system of claim 3, wherein the second set of machine-readable instructions cause the quantum computing device to at least solve the maximum cut problem based at least in part on the cost function and the quantum approximate optimization, a solution of the maximum cut problem corresponding to the two disjointed sets.

6. The system of claim 3, wherein the edge weights are based at least in part on a scanning data associated with the one or more vulnerability scans and dependency data.

7. The system of claim 6, wherein the scanning data comprises at least one of a common vulnerability scoring system (CVSS) score or an exploitability index score.

8. A method, comprising:
obtaining a graph comprising a plurality of nodes and a plurality of edges, the plurality of nodes representing a plurality of vulnerabilities in a computing infrastructure, and the plurality of edges representing one or more properties of the plurality of vulnerabilities;
defining a maximum cut problem based at least in part on the graph and edge weights assigned to the plurality of edges of the graph;
converting the maximum cut problem into a cost function for quantum approximate optimization; and
identifying a set of vulnerabilities from the plurality of vulnerabilities and an optimized prioritization of remediation for the set of vulnerabilities, the set of vulnerabilities corresponding to a solution of the maximum cut problem.

9. The method of claim 8, further comprising initializing a quantum circuit with a superposition of every possible combination for partitioning the graph into two sets of vulnerabilities.

10. The method of claim 9, wherein the quantum circuit comprises Hadamard gates, phase separator gates, and mixing gates.

11. The method of claim 9, wherein a plurality of qubits of the quantum circuit represent a plurality of states of the plurality of vulnerabilities of the graph.

12. The method of claim 11, further comprising applying iterative quantum operations to the qubits to evolve a quantum state towards a solution that maximizes the cost function.

13. The method of claim 8, wherein the edge weights are based at least in part on scanning data associated with one or more vulnerability scans of a computing infrastructure and vulnerability dependency data.

14. The method of claim 13, wherein the scanning data comprises at least one of a common vulnerability scoring system (CVSS) score or an exploitability index score.

15. A non-transitory, computer-readable medium, comprising machine-readable instructions that, when executed by a processor of a computing device, cause the computing device to at least:
initiate a scan of a computing infrastructure to identify a plurality of vulnerabilities within the computing infrastructure;
categorize vulnerability data associated with the plurality of vulnerabilities, the vulnerability data comprising scanning data obtained from scanning the computing infrastructure and vulnerability dependency data;
generate a graph of the plurality of vulnerabilities based at least in part on the categorized vulnerability data; and
identify a set of vulnerabilities of the plurality of vulnerabilities and a corresponding optimized remediation priority list for the set of vulnerabilities.

16. The non-transitory, computer-readable medium of claim 15, wherein the graph is generated to include a plurality of nodes representing the plurality of vulnerabilities and a plurality of edges representing a respective dependency between a respective two vulnerabilities of the plurality of vulnerabilities.

17. The non-transitory, computer-readable medium of claim 16, wherein the graph is partitioned into two disjointed sets such that a total weight of the plurality of edges between the two disjointed sets is maximized, the set of vulnerabilities corresponding to one disjointed set of the two disjointed sets.

18. The non-transitory, computer-readable medium of claim 15, wherein the graph is partitioned as a solution to a maximum cut problem, and the maximum cut problem being solved using quantum approximate optimization.

19. The non-transitory, computer-readable medium of claim 15, wherein the computing infrastructure is scanned using at least one of static application security testing, dynamic application security testing, software composition analysis, application programming interface scanning, container scanning, host scanning, database scanning, or network vulnerability scanning.

20. The non-transitory, computer-readable medium of claim 16, wherein the scanning data including at least one of common vulnerability scoring system (CVSS) and an exploitability index.
